(19) United States
(12) Patent Application Publication
(10) Pub. No.: US 2025/0277707 A1
(43) Pub. Date: Sep. 4, 2025

(54) METHOD FOR ASCERTAINING A TEMPERATURE OF A SWITCHABLE PANE IN A VEHICLE AND APPARATUS FOR CARRYING OUT THE METHOD

(71) Applicant: Webasto SE, Stockdorf (DE)

(72) Inventors: Rainer Staude, Stockdorf (DE); Nils Wittler, Stockdorf (DE)

(21) Appl. No.: 19/069,477

(22) Filed: Mar. 4, 2025

(30) Foreign Application Priority Data
Mar. 4, 2024 (DE) 102024201992.5

(51) Int. Cl. G01K 7/34; B60J 3/04; G01K 3/08; G02F 1/1334; G02F 1/137; G02F 1/169

(52) U.S. Cl. CPC G01K 7/34; G01K 3/08; G02F 1/137; B60J 3/04; G02F 1/1334; G02F 1/169

(57) ABSTRACT

Method for ascertaining a temperature of a variable-transparency, switchable pane which has a variable-transparency layer which, in order to switch said pane, is arranged between two transparent electrically conductive contact layers, comprising: applying an electrical reference voltage to the two contact layers; disconnecting one of the contact layers from the provided reference voltage at a predetermined first time; measuring a value of the residual voltage still remaining between the two contact layers during a discharge of the two contact layers through the variable-transparency layer during at least one second time which follows the predetermined first time and is temporally spaced apart from said first time; determining from the measurement a value of a parameter representing the discharge; and ascertaining a first value of the temperature of the switchable pane from the determined value for the parameter on the basis of an association rule between the parameter and the temperature by means of a control unit.

### CROSS-REFERENCE TO RELATED APPLICATION

This application claims priority to German Application No. DE 102024201992.5 filed on Mar. 4, 2024, which is incorporated herein by reference in its entirety for all purposes.

### TECHNICAL FIELD

The present disclosure relates to a method for ascertaining a temperature of a switchable pane in a vehicle and to an apparatus, or glass pane apparatus, for carrying out the method.

### TECHNICAL BACKGROUND

Switchable or smart glass is being used more and more not only in buildings but also in vehicles, for example as visual protection, for sunscreening or as part of ambient-light applications, etc. In the present disclosure, vehicles are understood to mean, inter alia, motor vehicles, including passenger cars and commercial vehicles, construction vehicles, aircraft, or ships, etc.

Switchable glass is usually provided in a laminated-glass structure in which two glass panes enclose a foil between them, which foil has a variable-transparency layer with a coating on both sides with contact layers which serve as surface electrodes. The variable-transparency layer can, e.g., comprise a material formed from LC (Liquid Crystal), PDLC (Polymer Dispersed Liquid Crystal) or SPD (Suspended Particle Device). Such materials change their optical properties, e.g. change from transparent to opaque and vice versa, when a voltage is applied to them.

In the case of PDLC, the liquid crystals enclosed in a solid polymer matrix orient themselves, for example, when a certain voltage is applied (corresponding to an ON state), so that incident light can pass through between the crystals directly and the switchable glass becomes transparent. When the voltage is switched off, the liquid crystals orient themselves again in a random way so that the incident light is scattered and the light transmission is thus interrupted. In this case, the switchable glass becomes opaque or milky.

The functionality of SPD is similar to that of LC or PDLC. In this case, the liquid in which rod-shaped SPD nanoparticles are suspended is an organic gel, more precisely a non-watery, electrically resistant liquid with a polymer stabilizer dissolved therein which reduces the tendency of the particles to agglomerate so that they are dispersed and held in suspension. When a voltage is not applied, SPD always still has a low light transmission and a blue colouring. When a voltage is applied, the blue colouring disappears (no more colouring) and the material as a whole becomes transparent.

The mentioned materials for the variable-transparency layer can change their optical properties in dependence on the applied voltage. In this way, it is possible to adjust light transmission by using a suitable voltage which is applied to the relevant contact layers. A switchable glass pane is usually operated with an alternating current since direct-current components can have a long-term disadvantageous effect on the material. The control for achieving a particular light transmission can be effected in this case by adjusting the amplitude and/or the frequency or by way of the duty cycle in pulse-width modulation.

It is known that the relationship between the optical properties of the material of the variable-transparency layer and the applied voltage is, however, also dependent on the temperature too. If only the states “switched on” (e.g. transparent) and “switched off” (e.g. opaque) are required, it is possible to select, for both states, a voltage value which can effect the desired limiting case (opaque or fully transparent) for all considered temperature values. However, it is more difficult if the user desires a particular value of a partial transparency. In this case, the control would, on the basis of the desired light transmission value, without further measures corresponding to an association between voltage values and light transmission values, select a voltage value which would then achieve, however, dependent on the temperature, a respective fully different result in terms of the light transmission actually effected. Because this is known, however, sensors, e.g. NTC-based sensors, are routinely installed in vehicles, for which example, sensors allow a temperature at or in the vicinity of the relevant glass panes to be measured or determined. On the basis of the measured temperature, the voltage value which is to be adjusted can be adapted such that, e.g., a deviation of the temperature from a reference value can be compensated for. Implementing a or even a plurality of independent temperature sensors in switchable panes can, however, entail increased material costs and a high cabling expense. Furthermore, such sensors are usually at the edge of a glass pane (or, in the case of a plurality of switchable panes, on another glass pane in the vehicle) and therefore potentially do not represent the temperature regime presently prevailing in the variable-transparency layer, with the consequence that, despite the use of sensors, incorrect light transmission is effected.

DE 10 2017 213 302 B3 describes a method for ascertaining a temperature in a switchable pane, during which a temperature is determined by measuring current consumption within the respective contact layers. For this purpose, a defined voltage is applied to one or both contact layers, in each case between two points within the contact layers. The current flows in dependence on the relevant voltage and the temperature-dependent resistance. The temperature can then be derived from the latter. The advantage is that the temperature can be determined in situ and that it is therefore possible to deliver more reliable values than methods for determining temperature using sensors.

In order to avoid a current flow through the intermediate variable-transparency layer in this case, however, the measurement must be performed symmetrically in both contact layers at the same voltage. This requires a neutral, discharged state of the capacitor formed by the contact layers, however. Measuring during operation, e.g. in a cyclical discharge phase that is actually present, is therefore rather ruled out and so the measurement entails a disruption to operation.

Alternatively, DE 10 2017 213 302 B3 proposes measuring the temperature-dependent impedance, which is inherent in the layer arrangement made up of the contact layers and the variable-transparency layer enclosed between them, in order to determine the temperature. However, it remains open here as to how the measurement could be carried out and by way of which design measures this could be effected, and whether this takes place during running operation or not.

### DESCRIPTION OF THE INVENTION

The present invention is therefore based on the object of providing a method for ascertaining a temperature of the switchable pane and here for example of the variable-transparency layer, and a corresponding apparatus, in the case of which, on the one hand, the expenditure and the costs are kept low and, on the other hand, the integration into the running operation of the switchable pane is simplified.

Various aspects of the invention propose a method for ascertaining a temperature of a variable-transparency, switchable pane which has a variable-transparency layer which, in order to switch said pane, is arranged between two transparent electrically conductive contact layers. The two contact layers serve as contact or surface electrodes using which an electrical voltage can be applied across the variable-transparency layer. For example, for this purpose, the contact layers can be provided with connection areas for making contact with cables using which power can be supplied, e.g. by a control unit.

According to one embodiment, the switchable pane or the variable-transparency layer can be formed from a PDLC material, an LC material or an SPD material. PDLC or LC are preferred. Furthermore, the two contact layers can be formed from a material comprising indium tin oxide (ITO), which is itself transparent, in order not to impair the light transmission of the pane. Other similar materials are likewise possible, however.

According to the method, an electrical reference voltage provided by a or the control unit is first of all applied to the two contact layers. The control unit can, e.g., comprise a microcontroller and a storage device. The microcontroller can be used, for example, to perform the measurement described below and the evaluation thereof in order to ascertain the temperature of the pane. The same or a different microcontroller can serve to output, during normal operation, a control signal which, e.g., is converted into an analogue signal in a known way by a digital-analogue converter element and is subsequently amplified by an amplifier element. The amplified signal can be used to periodically reverse the charge of the switchable pane during normal operation in order to control the light transmission. The amplifier element can have, for example, bridge operated by an operational amplifier. Other structures of a controller of the switchable pane are likewise possible.

The reference voltage applied to the contact layers can be a voltage provided by a power supply source, for example by a vehicle battery or a converter connected downstream of the latter, or else a specified maximum operating voltage resulting from the control signal which is output. This control signal can, however, also be used to set lower reference voltages and the magnitude of the reference voltage is arbitrary in and of itself so long as the components are not damaged (upper limit) or the level is so low that a decay curve which is to be subsequently determined is no longer able to be measured with sufficient resolution (lower limit).

Applying the reference voltage can coincide with applying a voltage which is applied during normal operation. It is important, for the subsequent determination or characterization of a decay curve, that the value of this voltage or of the reference voltage is known in order to be able to carry out a comparison with subsequently measured values of a residual voltage. Furthermore, it is preferred that the applied reference voltage is kept constant for a period of time before disconnecting, to be described below, one of the contact layers from the power supply. This rules out that charge-reversal processes are still running at the time of the disconnection. Rather, the capacitor formed from the contact layers is charged substantially in accordance with the reference voltage. The time constant for charging τ=Rs·C is formed from the capacitor (C), formed by the two contact layers, and the resistor Rs of the contact layers. For example, the minimum period of time for applying the constant reference voltage can be a factor 2, preferably a factor 5, more preferably a factor 10, of this time constant.

Next, there follows the above-indicated disconnection of at least one of the charged contact layers from the provided reference voltage at a predetermined first time. As a result, a discharge of the contact layers acting as a capacitor may now only take place via the intermediate variable-transparency layer which as an ohmic resistor allows a current flow. The disconnection can be effected by an additional switch in the circuit structure of the amplifier circuit. In addition, a high-resistance voltage divider for measuring the respective voltage is also possibly connected in parallel. The influence of the parallel-connected voltage divider can be deducted.

According to the equivalent circuit diagram shown in FIG. 1, which shows the arrangement of the two contact layers and of the intermediate variable-transparency layer, the capacitor formed by the two contact layers and charged in accordance with the reference voltage can be discharged via the intermediate variable-transparency layer. The speed of the discharge is temperature-dependent since both the capacitance of the two contact layers and the ohmic resistance of the variable-transparency layer may depend on the temperature. The disclosure therefore exploits the fact that the temperature can be deduced by determining the discharge speed.

For this purpose, a value of the voltage, referred to below as the residual voltage, still remaining between the two contact layers during a discharge of the two contact layers through the variable-transparency layer is next measured during at least one second time which follows the predetermined first time and is temporally spaced apart from said first time. In the ideal case, the discharge curve corresponds to an exponentially decreasing curve. The discharge curve characterizing the discharge is clearly defined by the reference voltage and the residual voltage which is measured during at least one further time.

In order to quantify the discharge curve in one parameter, a characteristic value can be determined, wherein the parameter represents the discharge.

For example, the parameter can be the time constant τ=Rp·C of the capacitor (C) formed by the two contact layers and of the resistor (Rp) formed by the variable-transparency layer. The discharge curve can be determined from the two measured values for the two times, and that time after which the residual voltage has decreased to the factor 1/e can be calculated. This time corresponds to the time constant.

Alternatively, according to another exemplary embodiment, the value of the voltage measured at a fixed specified second time can be used as the parameter, whereby the measured value is equal to the value of the parameter.

According to a further alternative, it is possible to determine a time required until the voltage has dropped to a factor (less than 1) of the original reference voltage. The voltage measurement can be supported here by a circuit measurement arrangement having a comparator which compares the measured voltage with a corresponding comparison voltage which corresponds to the factor. The factor can, e.g., be 1/e which directly corresponds to the time constant; other factors are likewise possible, however. The period of time until the measured voltage value falls below the comparison voltage can be measured or determined by a timer. In this exemplary embodiment, the period of time is the parameter representing the discharge.

The aspect according to the disclosure furthermore makes provision for a first value of the temperature of the switchable pane to be ascertained from the determined value (e.g. the time constant, the dropped voltage at the second time, the time until a comparison voltage is reached, etc.) for the parameter on the basis of an association rule between the parameter and the temperature by means of the control unit.

The association rule can, e.g., be a table, optionally with interpolation, an approximation equation determined from a fit, an algorithm and/or else an AI scheme, which is applied by the control unit. The association rule assigns a (first) value for the temperature to the value for the parameter.

It should be noted that a possibly provided high-resistance voltage divider for measuring the respective voltage between the contact layers possesses a proportion on the discharge curve. This can be deducted or equally accordingly taken into account in the association table.

The aspects of the invention which are proposed here allow electrical properties of the contact layers and even of the variable-transparency layer itself, which are each temperature dependent, to be advantageously measured. As a result, precise determination of the temperature in situ and in real time is made possible. Furthermore, the aspects allow good integration into the normal operating procedure because cyclical charge-reversal phases, which take place anyway, can be used for the measurement.

According to exemplary embodiments, the measuring of the value of the residual voltage still remaining during a discharge of the two contact layers can involve the second time being predetermined and specified. In this case, the value of the parameter can be calculated from the measured voltage or be identified using same.

Alternatively, the measuring of the voltage can involve specifying a value of the residual voltage which is reduced with respect to the reference voltage by a factor. A second time is determined from repeatedly or continuously measuring the residual voltage, up to which second time the measured residual voltage has fallen to the reduced value of the voltage. The value of the parameter can then be calculated from the time difference between the first time and the second time or be identified using same. According to a further exemplary embodiment of the method, the control unit, at least for the case in which two or more possible values of the temperature can be determined from the association rule on the basis of the determined value of the parameter of the discharge, obtains a second value of a temperature of an environment via a measurement by means of a temperature sensor. This proposed solution solves a particular problem that, e.g., the mentioned time constant as the parameter representing the discharge, for the mentioned common materials of the variable-transparency layer, such as PDLC, for instance, over the range of possible temperatures in vehicles (e.g. −40° C. to +80° C.), in some circumstances very roughly considered, has the shape of a bell or parabola open towards the bottom, with the consequence that two or possibly even three values of the temperature can be associated with a value for the parameter. The shape of the time constant over the temperature is, however, dependent on the used variable-transparency layer or the corresponding foil material. Using a possibly also only roughly measured (second) temperature value of an environment of the switchable pane by means of a temperature sensor, it is possible to distinguish here in which section of the temperature scale the association rule should be applied so that only still a (now exact) first temperature value comes into consideration. In order not to go against the aim of the disclosure of achieving an expenditure and cost saving by dispensing with temperature sensors on or in the vicinity of the switchable panes, a temperature sensor which is usually always present in the relevant ECU of the vehicle can preferably be used for this purpose.

This second value of the temperature can then be compared with the possible values determined from the association rule. Based on the comparison, in this exemplary embodiment, one of the possible values determined from the association rule is selected as the valid first value of the temperature.

A further exemplary embodiment makes provision for the control unit, based on the now ascertained temperature, to calculate a control signal for setting a specified light transmission of the pane on the basis of the first temperature value and output said control signal. In other words, the voltage range is adapted such that, for setting a desired light transmission, temperature differences or changes are compensated for. The effect can be compensated for, for example, by varying the applied voltage generated by the control unit (e.g. the ECU), namely in terms of amplitude and shape (rectangle, sawtooth, sinusoidal shape, trapezoidal shape) and/or the frequency in dependence on the temperature and also on the time (age and/or number of switching cycles).

A further exemplary embodiment makes provision for the disconnection of one of the two contact layers from the provided voltage to be carried out using an additional switch which is not part of an amplifier circuit for reversing the charge of the contact layers making up the capacitor.

A further aspect of the present disclosure makes provision for a glass pane apparatus for a variable-transparency, switchable pane, wherein the glass pane apparatus has a control apparatus which is configured to carry out the method as outlined above. This achieves the same advantages as described above. The control apparatus can also be part of an ECU.

Overall, the aspects and exemplary embodiments of the method and apparatus presented here make it possible to obtain consistent optical properties of the switchable glazing over the range of application temperatures and also the vehicle age or the useful life for the user.

The invention is e.g. designed for use in vehicles, for example in glass roofs, windows, or front or rear windscreens of motor vehicles, or else of partitions in taxis or buses between the driver and the passenger space. As mentioned at the outset, the invention can, however, also be used in trucks, construction vehicles, ships or aircraft, etc., where a transparent, that is to say see-through, and an opaque, that is to say non-see-through, state are required or are desired by a customer.

### BRIEF DESCRIPTION OF THE DRAWINGS

The invention is explained by way of example below with reference to the following figures, in which:

FIG. 1 shows, in a sketched circuit diagram, an overview of a pane apparatus 2 according to one exemplary embodiment illustrated in a very simplified manner;

FIG. 2 shows a diagram in which the transmission of the switchable pane 4 in relation to the applied voltage U is shown for three different temperatures (−10° C., 0° C., 20° C.);

FIG. 3 shows, in a schematic diagram, the characteristic of the capacitance of a capacitor C composed of two contact layers, and of the resistor Rp of the intermediate variable-transparency layer in a switchable pane over a relevant temperature range;

FIG. 4 shows, in a diagram, discharge curves measured according to aspects of the invention for 9 different temperatures between −40° C. and +100° C. for a switchable pane 4 with the residual voltage, schematically plotted against time;

FIG. 5 shows, in a diagram, the time constants, which are able to be derived for each of the 9 curves from FIG. 4, plotted against temperature;

FIG. 6 shows, in a flowchart, a sequence of a method for ascertaining the temperature of a switchable pane according to one exemplary embodiment.

### DETAILED DESCRIPTION OF PREFERRED EXEMPLARY EMBODIMENTS

In the following description of the drawings, identical reference signs denote identical or comparable components. The features of the invention which are disclosed in the preceding description, in the drawings and in the claims can be essential to realizing the invention both individually and in any combination.

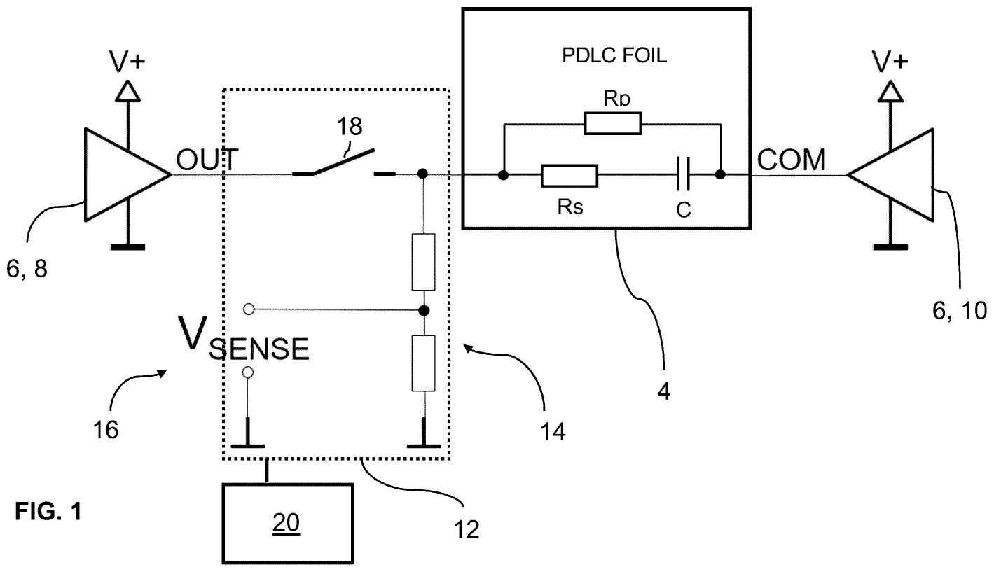

FIG. 1 shows, in a sketched circuit diagram, an overview of a glass pane apparatus 2 illustrated in a very simplified manner, on the basis of which a method according to one exemplary embodiment can be performed. The pane apparatus 2 has a switchable pane 4 which in the circuit diagram is illustrated only as an RC element in the form of an equivalent circuit diagram.

The switchable pane 4 comprises an arrangement composed of two contact layers and an intermediate variable-transparency layer. The two contact layers form, with the intermediate variable-transparency layer, a capacitor C. A current can flow between the two contact layers through the intermediate variable-transparency layer. The variable-transparency layer therefore forms a resistor Rp which is connected in parallel with the capacitor C in the equivalent circuit diagram since it allows bypassing. Furthermore, the contact layers themselves have a resistor Rs which is connected in series with the capacitor C. Connections, which are not illustrated, to the two contact layers allow a voltage to be applied.

In the exemplary embodiment, the switchable pane (also referred to as foil) or the variable-transparency layer comprises a PDLC material. In the exemplary embodiment, the two contact layers are formed from a material comprising indium tin oxide (ITO), which is itself transparent, in order not to impair the light transmission of the pane.

The glass pane apparatus 2 further has a control unit 6 which has a first analogue amplifier 8 and a second analogue amplifier 10. For the sake of simplicity, only the two analogue amplifiers 8, 10 of the control unit 6 are illustrated in the figure. It goes without saying that this type of illustration imposes no restriction on the control unit 6. Rather, yet further components which are not described here can be part of the control unit 6. The switchable pane 4 is connected between an output OUT of the first analogue amplifier 8 and an output COM of the second analogue amplifier 10.

The control unit 6 controls the switchable pane 4 with a control voltage which is composed of a first alternating voltage signal, which is amplified by the first analogue amplifier 8, and a second alternating voltage signal, which is amplified by the second analogue amplifier 10. In this case, the first alternating voltage signal is electrically phase-shifted, preferably by 180°, with respect to the second alternating voltage signal.

A measuring 12 for measuring a discharge voltage or residual voltage in the capacitor C is connected between the output OUT of the first analogue amplifier 8 and one of the two connections of the switchable pane 4. The measuring apparatus 12 additionally comprises a voltage divider 14 which has two resistors connected in series and which is connected on one side to the connection of the switchable pane 4 or to one of the two contact layers and is connected on the other side to earth or earth potential. A centre tap between the two series-connected resistors of the voltage divider 14 is connected to a measuring unit 16 which can sense a present voltage VSENSE. The voltage VSENSE is in a fixed relationship, defined by the voltage divider, with the remaining residual voltage in the capacitor. In this respect, the measuring unit or the measuring apparatus also indirectly senses the residual voltage.

The measuring apparatus 12 further has an electronic switch 18. The electronic switch 18 can be actuated by a control apparatus 20 which is also connected to the measuring unit 16. The electronic switch 18 can be switched on and off. As a result, the switchable pane 4 can be completely disconnected from, or else supplied by, a voltage applied by the control unit 6.

This structure makes it possible for the measuring unit 16 to monitor a discharge of the capacitor C by virtue of it measuring the voltage VSENSE which is dropped across the voltage divider 14 from a first time t1 at which the control apparatus 20 has opened the electronic switch 18. Beforehand, when the switch is closed, the control apparatus may have charged the capacitor C for a minimum period of time, e.g. with a direct voltage, to a reference voltage UREF; in the exemplary embodiment which does not restrict the generality, 60 V for example. For this purpose, the control apparatus can also be connected to the control unit 6, or to another controller which controls the latter, in order to allow defined charging of the capacitor C. By determining the temporal discharge curve, it is possible, according to the exemplary embodiment according to the disclosure, to ascertain a temperature prevailing directly in the switchable pane 4, as is described below.

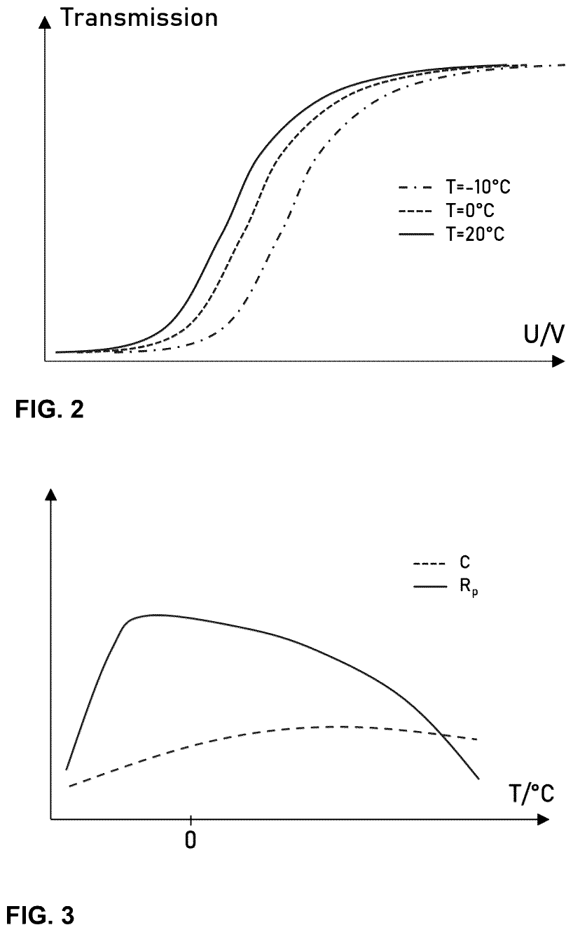

FIG. 2 shows a diagram in which the transmission or light transmission of the switchable pane 4 in relation to the applied voltage U is shown for three different temperatures (−10° C., 0° C., 20° C.). A dependency on temperature can clearly be seen in that a range in which only partial darkening can be set (transmission»0, but also «1) extends over different voltage intervals. Measuring the temperature according to the disclosure makes it possible, e.g., to begin compensating for this effect by adapting, for example, the associations of voltages with desired respectively degrees of transmission in a temperature-dependent manner.

FIG. 3 shows, in a schematic diagram, the characteristic of the capacitance of a capacitor C composed of the two contact layers, and of the resistor Rp of the intermediate variable-transparency layer over a temperature range relevant in the scope of application (vehicles), including the freezing point. This fact is used by the exemplary embodiment. The capacitance of the capacitor C composed of the two contact layers, and the resistor Rp of the intermediate variable-transparency layer, form an RC element with a time constant τ=Rp·C. This time constant is reflected in the discharge curve measured according to the exemplary embodiment; it is the time during which the residual voltage still remaining in the capacitor has dropped, starting from the reference voltage, to a value 1/e.

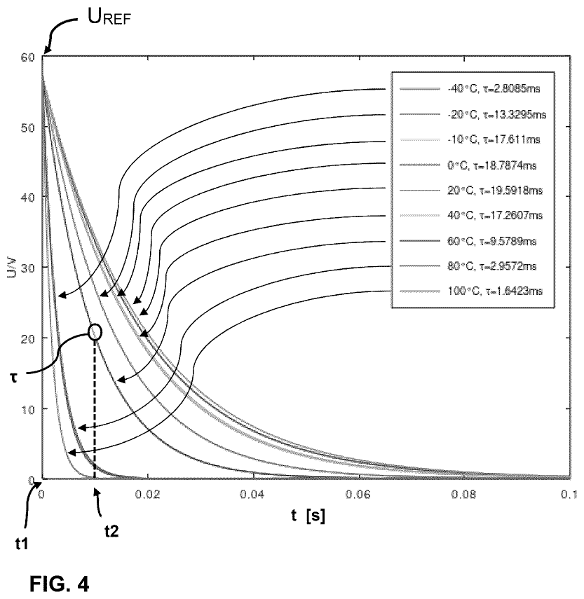

FIG. 4 shows, in a diagram, discharge curves theoretically determined for 9 different temperatures between −40° C. and +100° C. for a specific switchable pane 4 with the residual voltage, schematically plotted against time. The reference voltage UREF here is, for example, 60 V. The value of the time constant τ=Rp·C is recorded in the diagram by way of example for a discharge curve which has been taken at T=60° C. (for instance 0.01 s). The residual voltage here is only still somewhat more than 20 V (=60 V/e).

According to one alternative of the method provided in the exemplary embodiment, starting from the first time t1 at which the switchable pane 4 is disconnected from the reference voltage UREF by the switch 18, a time difference up to a second time t2 is measured, at which second time the residual voltage U has dropped to a value which is less than the reference voltage UREF by a specified factor, for example a factor 1/e. This time difference ascertained by measurement (for this purpose, provision can additionally be made for a timer (not illustrated), e.g. in the measuring apparatus 12 or in the control apparatus 20) is a parameter which is derived from the residual voltage measurement and which is characteristic of the discharge or the discharge curve.

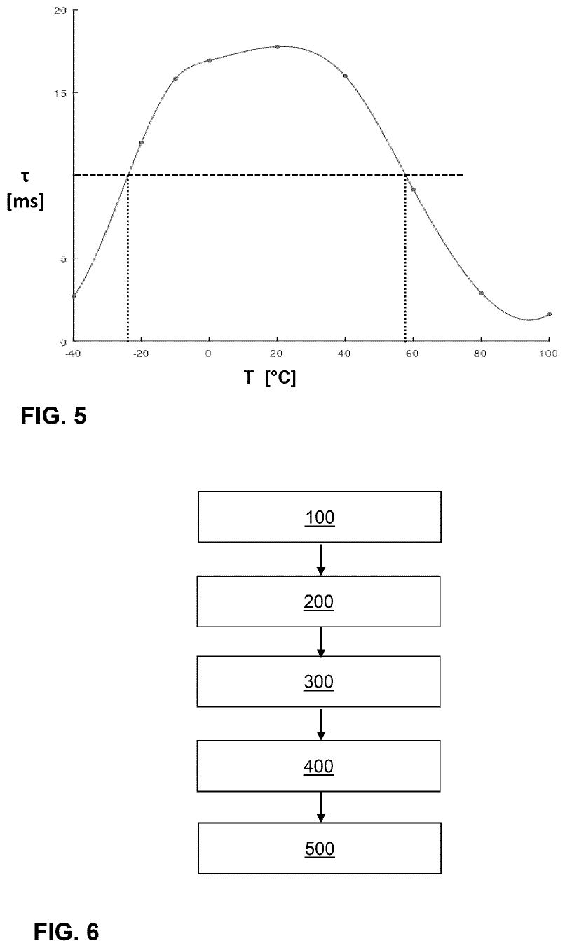

FIG. 5 shows, in a diagram, the time constants, which are able to be derived for each of the 9 curves from FIG. 4, plotted against temperature. In some circumstances, a constant curve can result, partly in the form of a parabola open towards the bottom. In accordance with this diagram, an association rule, for example in the form of a table or a mathematical function, can be created beforehand through theory or experiment, which association rule associates a temperature with the values of the parameters (in the exemplary embodiment, of the measured time difference).

If the method according to the invention is now used to measure a time difference between the first time t1 and the second time t2, which, as depicted in FIG. 4, is 0.01 s (10 ms), for instance, a horizontal line thus additionally arises in the diagram of FIG. 5 at the corresponding point. However, due to the parabolic shape, the association is not clear: for the parameter (time difference) determined from measurement, an association can be found both at T=−24° C. and at T=+57° C. For this purpose, the control apparatus 20, which may, e.g., also be an ECU, can have access to a temperature sensor which is provided elsewhere anyway and which allows reliable discrimination between a higher temperature range and a lower temperature range. In this way, the correct temperature can be identified and used for the further control of the glass pane apparatus.

FIG. 6 shows, in a flowchart, an exemplary sequence of the method for ascertaining the temperature of a switchable pane according to one exemplary embodiment.

In step 100, an electrical reference voltage U_{REF} is applied to the two contact layers.

In step 200, one of the contact layers is disconnected from the provided reference voltage at a predetermined first time t1.

In step 300, a value of the residual voltage still remaining between the two contact layers during a discharge of the two contact layers through the variable-transparency layer is measured during at least one second time t2 which follows the predetermined first time t1 and is temporally spaced apart from said first time.

In step 400, a value of a parameter representing the discharge is determined from the measurement, for example, as described above, a time difference, or a residual voltage measured at a fixed specified second time can also be used as such as the parameter, etc.

In step 500, a first value of the temperature of the switchable pane 4 is ascertained from the determined value for the parameter on the basis of an association rule between the parameter and the temperature by means of a control unit.

### LIST OF REFERENCE SIGNS

2 glass pane apparatus
4 switchable pane
6 control unit
8 first analogue amplifier
10 second analogue amplifier
12 measuring apparatus
14 voltage divider
16 measuring unit
18 electronic switch
20 control apparatus
100 applying a reference voltage to contact layers
200 disconnecting the contact layers from the reference voltage
300 measuring the voltage or the discharge current between contact layers
400 determining from the measured values a parameter value representing the discharge
500 ascertaining a temperature from the parameter value on the basis of an association rule

1: A method for ascertaining a temperature of a variable-transparency, switchable pane which has a variable-transparency layer which, in order to switch said pane, is arranged between two transparent electrically conductive contact layers, comprising:
applying an electrical reference voltage to the two contact layers;
disconnecting one of the contact layers from the provided reference voltage at a predetermined first time;
measuring a value of the residual voltage still remaining between the two contact layers during a discharge of the two contact layers through the variable-transparency layer during at least one second time which follows the predetermined first time and is temporally spaced apart from said first time;
determining from the measurement a value of a parameter representing the discharge; and
ascertaining a first value of the temperature of the switchable pane from the determined value for the parameter on the basis of an association rule between the parameter and the temperature by means of a control unit.

2: The method according to claim 1, wherein
the parameter represents the electrical discharge of a capacitor formed by the two contact layers via a resistor formed by the variable-transparency layer.

3: The method according to claim 2, wherein
the parameter is the time constant τ=Rₚ·C of the capacitor formed by the two contact layers and of the resistor formed by the variable-transparency layer.

4: The method according to claim 3, wherein the measuring further comprises at least one of:
specifying the predetermined second time at which the residual voltage is measured, wherein the value of the parameter is calculated from the measured residual voltage or is identified using same; and
specifying a value of the voltage which is reduced with respect to the reference voltage by a factor, wherein a second time is determined from at least one of: repeatedly and continuously measuring the residual voltage, up to which second time the measured residual voltage has dropped to the reduced value of the voltage, wherein the value of the parameter is calculated from the time difference between the first time and the second time or is identified using same.

5: The method according to claim 4, wherein the control unit: at least for the case in which two or more possible values of the temperature can be determined from the association rule on the basis of the determined value of the parameter of the discharge, obtains a second value of a temperature of an environment via a measurement by means of a temperature sensor, further comprises:
comparing this second value of the temperature with the possible values determined from the association rule, and
selecting, based on the comparison, one of the possible values determined from the association rule as the valid first value of the temperature.

6: The method according to claim 5, wherein the variable-transparency layer is formed from at least one of: a PDLC material, an LC material, and an SPD material.

7: The method according to claim 6, wherein the two contact layers are formed from a material comprising indium tin oxide (ITO).

8: The method according to claim 7, wherein a control signal for setting a specified light transmission of the pane is calculated on the basis of the first value of the temperature and is output.

9: The method according to claim 8, wherein the applying, disconnecting, measuring, determining, and ascertaining are carried out during a cyclic charge reversal in a discharge phase of the switchable pane.

10: The method according to claim 9, wherein the disconnection of a contact layer from the provided reference voltage is carried out using an additional electronic switch which is not part of an amplifier circuit for reversing the charge of the contact layers making up the capacitor.

11: A glass pane apparatus having a variable-transparency, switchable pane, wherein the glass pane apparatus has a control unit which is configured to:
applying an electrical reference voltage to the two contact layers;
disconnect one of the contact layers from the provided reference voltage at a predetermined first time;
measuring a value of the residual voltage still remaining between the two contact layers during a discharge of the two contact layers through the variable-transparency layer during at least one second time which follows the predetermined first time and is temporally spaced apart from said first time;
determine from the measurement a value of a parameter representing the discharge; and
ascertain a first value of the temperature of the switchable pane from the determined value for the parameter on the basis of an association rule between the parameter and the temperature by means of a control unit.
